(19) United States
(12) Patent Application Publication
(10) Pub. No.: US 2003/0011488 A1
(43) Pub. Date: Jan. 16, 2003

(54) Wireless remote interactive display system

(76) Inventors: Gregory Chotkowski, New York, NY (US); J. Jeffrey Freda, Montclair, NJ (US)

Correspondence Address: DARA L ONOFRIO, ONOFRIO LAW, 1133 BROADWAY, SUITE 1600, NEW YORK, NY, 10010, US

(21) Appl. No.: 10/115,225

(22) Filed: Apr. 3, 2002

Related U.S. Application Data
(60) Provisional application No. 60/281,439, filed on Apr. 4, 2001.

(51) Int. Cl. G08C 19/00

(52) U.S. Cl. 340/825.72

(57) ABSTRACT

A wireless remote interactive display system and related method comprising a display, preferably a storefront window display, a wireless broadcast device located in said display for broadcast of information, means for transferring information from said wireless broadcast device to an enduser with a mobile wireless remote device and means for receiving and accepting information from said wireless broadcast device on the enduser's mobile wireless device. The enduser uses the information received from the wireless broadcast device to interact with the display.

### FIELD OF THE INVENTION

The present invention relates to a wireless device for broadcast of information. More particularly, it relates to an electronic system for providing automated wireless broadcast of information to individuals using mobile wireless devices for interaction with a display system, preferably in a storefront window.

### BACKGROUND OF THE INVENTION

Communication of certain information, i.e. business cards, menus, flyers, coupons, advertisement and promotional information etc. by merchants to customers is inefficient and impractical because these items are easily lost, misplaced or discarded.

Further, retail storefront window displays have long served as a means for marketing merchandise to customers. Displays have evolved from simple shelves for showcasing actual products to elaborate works of art. At various times, mechanical systems have been incorporated to change static exhibits to dynamic ones. Recent advances in technology have even enabled display devices which change digital images in order to target different customer segments based on the time of day.

A few “interactive” displays have been designed in which a switch or button, hardwired to the store exterior, can be manipulated by a passerby to actuate some mechanical system with the storefront display. Their ability to enrich the experience and engage the customer is an effective marketing tool. Typically, the exterior switches or buttons have been used to actuate simple devices such as a light or sound system. When integrated with any type of electrically powered device (e.g. toy train), most systems have only been able to accommodate one device.

The invention overcomes these problem by providing a method and apparatus for broadcasting digital information wirelessly from a free standing broadcast device located in a window display, preferably in a store front, to a personal portable device. The information retrieved permits interaction with the display by an individual as well as multiple users.

The invention also provides a method and means for linking information captured on the portable device to an electronic network. This electronic network, among other things, is for consumers to store information about selected merchants and to match up offers and promotions from merchants to consumers and to facilitate various e-commerce activities.

Storing, receiving and accessing information according to the invention is easier than conventional print medium.

### SUMMARY OF THE INVENTION

The invention provides a wireless remote interactive display system comprising a display, preferably in a storefront; a wireless broadcast device located in the display for broadcast of information; means for transferring information from said wireless broadcast device to an enduser with a mobile wireless remote device; means for receiving and accepting information from said wireless broadcast device on the enduser's said mobile wireless device; wherein the enduser uses the information received from said wireless broadcast device to interact with said storefront window display.

The wireless device for broadcast of information comprises a medium, a means for storing information on said medium and a means for transmitting the information on said medium to a mobile wireless device.

The broadcast device itself may have external or a self-contained power source. It may also have a fixed broadcast message or a means to be reprogrammed.

Other objects, features and advantages of the present invention will be apparent when the detailed description of the preferred embodiments of the invention are considered with reference to the drawings, which should be construed in an illustrative and not limiting sense as follows:

### BRIEF DESCRIPTION OF THE DRAWINGS

FIG. 1 illustrates, in general, the wireless remote interactive system according to the invention;

FIG. 2 illustrates a wireless broadcaster device according to the invention in a storefront window;

FIG. 3 illustrates an enduser with a mobile wireless remote device obtaining information from the wireless broadcaster device; and

FIG. 4 illustrates interaction of the enduser with the window display using the information obtained from the wireless broadcaster device.

### DETAILED DESCRIPTION OF THE INVENTION

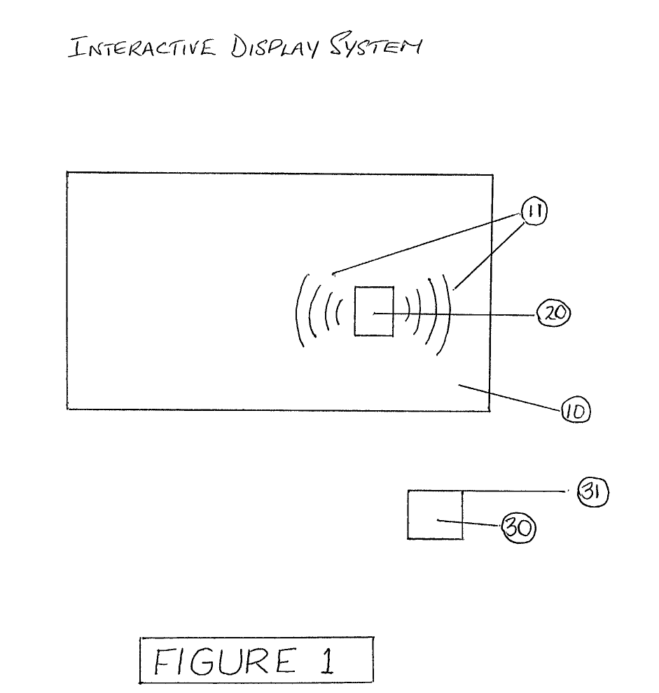

As illustrated in FIG. 1, the invention provides in general a wireless remote interactive display system comprising a display 10; a wireless broadcast device 20 located in the display for broadcast of information; means for transferring information 11 from said wireless broadcast device to an enduser with a mobile wireless remote device 30; means for receiving and accepting information from said wireless broadcast device on the enduser's said mobile wireless device 31; wherein the enduser uses the information received from said wireless broadcast device to interact with said display (not illustrated in FIG. 1).

A preferred application of the system and method of the invention is in a window storefront display.

Actuation of the electrically powered devices within the storefront window display by any enduser on the outside of the display is accomplished through a series of receiving and transmitting devices employing signals from various frequencies of the electromagnetic spectrum (e.g. “Bluetooth” or other radio frequency). When combined with a series of software applications, a remote controller is created that enables manipulation of the signals for precise control of the object devices. Consumers/endusers can create their own remote controls by downloading the controlling software onto their wireless remote devices such as the infrared enabled Personal Digital Assistants or cell phones.

The elements of the system include:

1. Wireless signal receivers that convert mechanically actuated switches of an object device (e.g. the “on-off” switch on a television set) to wireless actuated switches such as that of an infrared television remote control.

2. Software applications that enable desired manipulation of wireless signals for precise control of object devices referred to above.

3. A system and method for transferring software applications to any compatible handheld devices for the purpose of enabling handheld devices as remote controllers of object devices referred to above.

4. Handheld devices capable of receiving, storing and correcting executing software applications transferred as described above.

The following example will serve to illustrate the invention. This example is merely representative and are not inclusive of all the possible embodiments of the invention.

### EXAMPLE 1

An example of the sequence of steps required for implementation of the system in a storefront window display according to the invention is as follows:

The desired object devices in the storefront display are converted from mechanically actuated to wirelessly actuated, for example an electrically powered toy train.

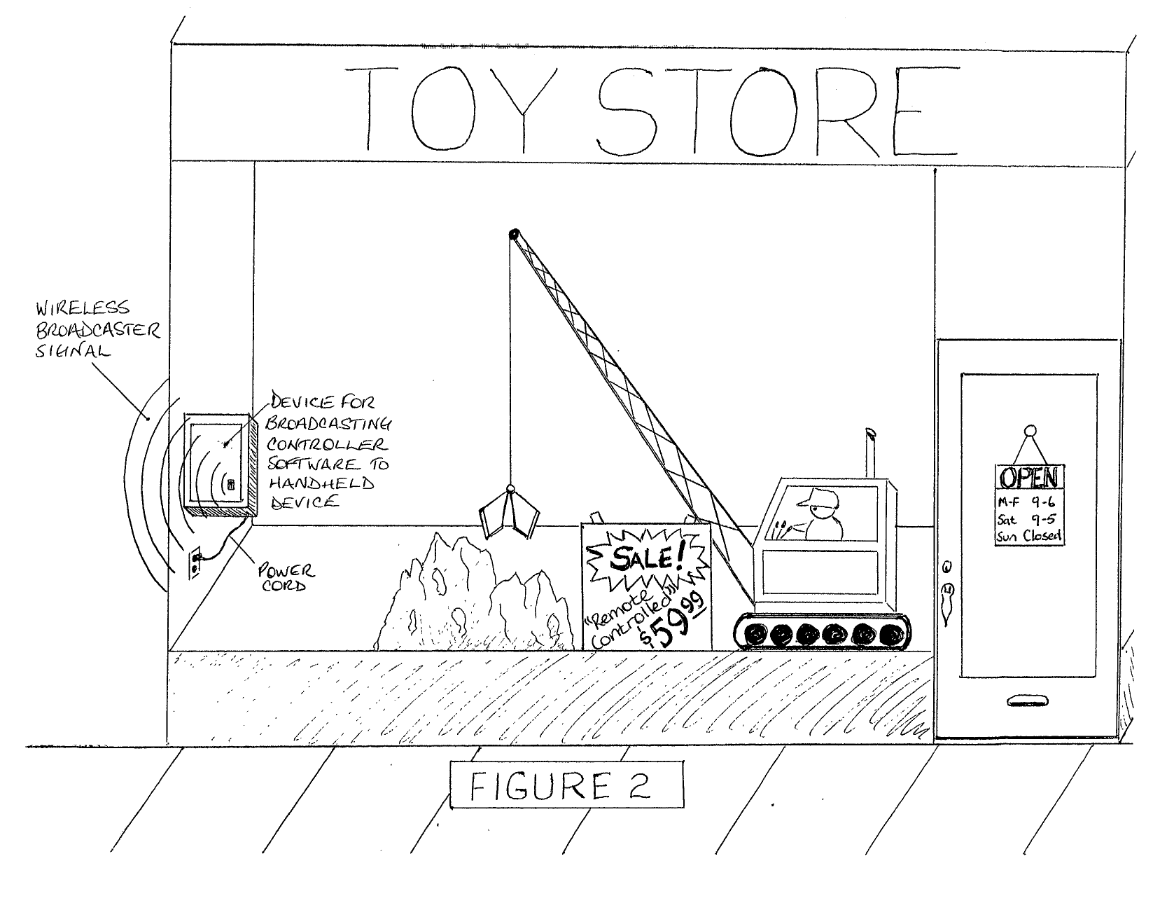

These object devices are placed in the storefront window display. See FIG. 2.

A wireless broadcast device is installed in the window display that transfers software applications to handheld devices such as Palm type Personal Digital Assistants and cell phones. See FIG. 2.

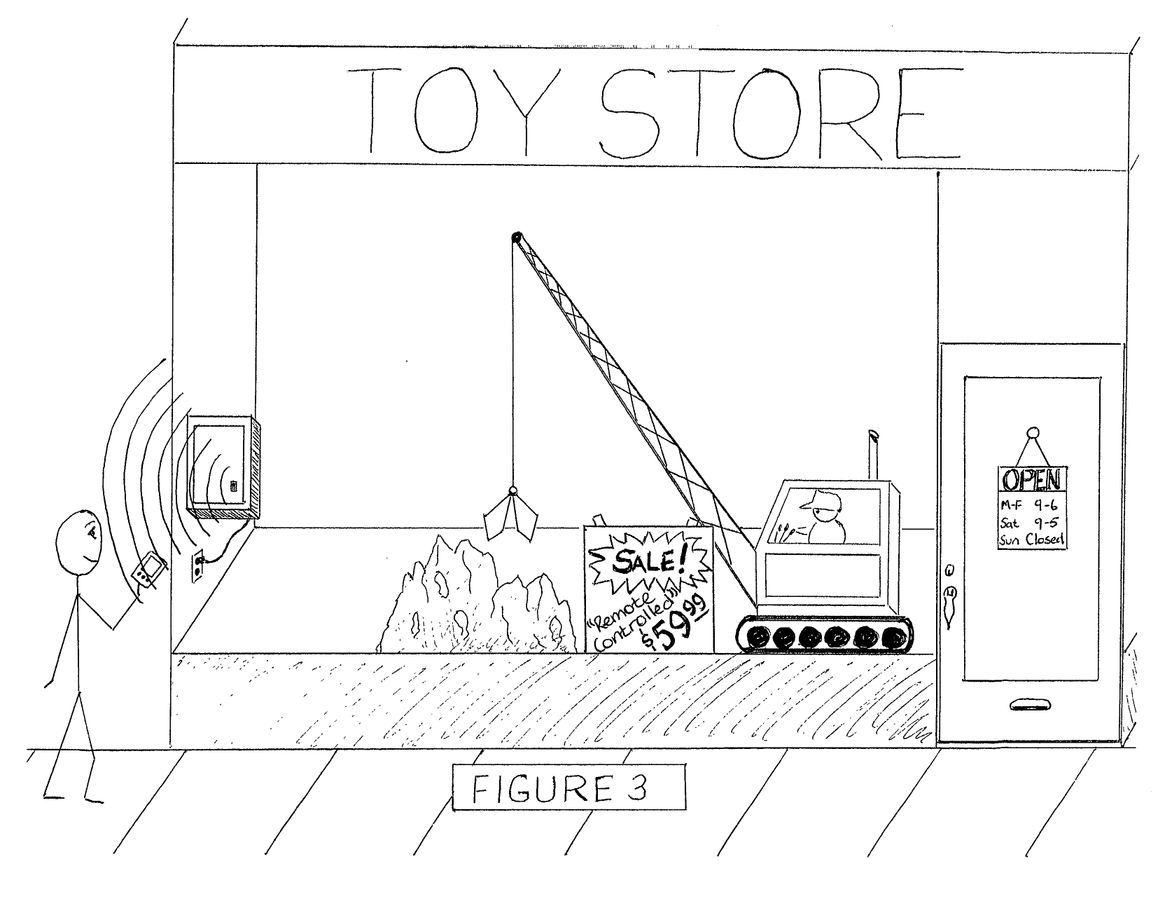

The software applications are transferred and accepted from the wireless broadcast device to the consumer's handheld device. See FIG. 3.

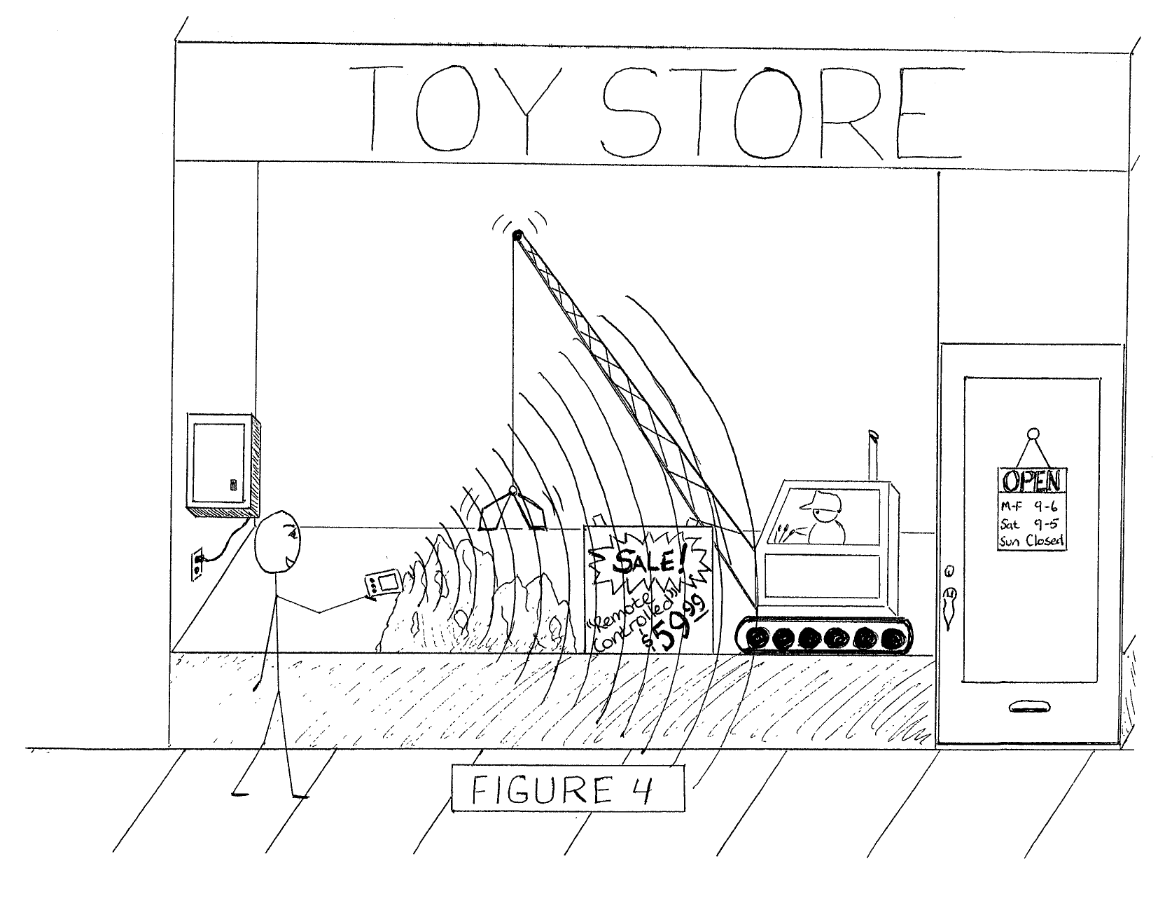

The handheld device is configured by the software applications to enable the device as a remote controller of the object devices in the window display. Whereby the consumer can interact with the window display using the handheld device. See FIG. 4.

The invention now being fully described, it will be apparent to one of ordinary skill in the art that many changes and modifications can be made thereto without departing from the spirit or scope of the invention as set forth herein.

What is claimed is:

1. A wireless remote interactive display system comprising:
a storefront display;
a wireless broadcast device located in said display for broadcast of information;
means for transferring information from said wireless broadcast device to an enduser with a mobile wireless remote device;
means for receiving and accepting information from said wireless broadcast device on the enduser's said mobile wireless device;
wherein the enduser uses the information received from said wireless broadcast device to interact with said display.

2. The system as defined in claim 1, wherein said wireless broadcast device comprises:
a medium;
a means for storing information on said medium; and
a means for transmitting the information on said medium to a mobile wireless device.

3. The system as defined in claim 2, wherein said wireless broadcast device further comprising a means for storing, accessing and/or managing the information.

4. The system as defined in claim 2, wherein said wireless broadcast device further comprising a means for communicating between said mobile wireless device and the wireless device.

5. The system as defined in claim 1, wherein said display is a storefront window display.

6. A method for broadcasting information from a wireless device for interaction with a display comprising the steps of:
providing a wireless device containing information;
transmitting the information from said wireless device;
capturing of the information by a mobile wireless device;
wherein the information captured by said mobile wireless device is used to interact with the display.

7. The method as defined in claim 6, comprising the further step of storing, accessing and/or managing the information.

8. The method as defined in claim 6, comprising the further step of connecting to an electronic network for utilization of the information.

9. The method as defined in claim 6, wherein said display is a storefront window display.

10. A wireless remote interactive storefront display system comprising:
a storefront display;
a wireless broadcast device located in said storefront display for broadcast of information;
means for transferring information from said wireless broadcast device to an enduser with a mobile wireless remote device;
means for receiving and accepting information from said wireless broadcast device on the enduser's said mobile wireless device;
wherein the enduser uses the information received from said wireless broadcast device to interact with said storefront display.

11. The system as defined in claim 10, wherein said wireless broadcast device comprises:
a medium;
a means for storing information on said medium; and
a means for transmitting the information on said medium to a mobile wireless device.

12. The system as defined in claim 11, wherein said wireless broadcast device further comprising a means for storing, accessing and/or managing the information.

13. The system as defined in claim 11, wherein said wireless broadcast device further comprising a means for communicating between said mobile wireless device and the wireless device.

14. A method for broadcasting information from a wireless device for interaction with a storefront display comprising the steps of:
providing a wireless device containing information;
transmitting the information from said wireless device;
capturing of the information by a mobile wireless device;
wherein the information captured by said mobile wireless device is used to interact with the storefront display.

15. The method as defined in claim 14, comprising the further step of storing, accessing and/or managing the information.

16. The method as defined in claim 14, comprising the further step of connecting to an electronic network for utilization of the information.
